(19) United States
(12) Patent Application Publication
(10) Pub. No.: US 2025/0298476 A1
(43) Pub. Date: Sep. 25, 2025

(54) MOUSE PAD MANUFACTURING DEVICE FOR VARIOUS COIL THICKNESS

(71) Applicant: YUHONG ELECTRONIC (SHENZHEN) CO., LTD., Shenzhen (CN)

(72) Inventor: Wei-Jen LIANG, New Taipei City (TW)

(21) Appl. No.: 18/609,242

(22) Filed: Mar. 19, 2024

(51) Int. Cl. G06F 3/039; B29D 7/00; B29L 31/00

(52) U.S. Cl. CPC G06F 3/0395; B29D 7/00; B29L 2031/76

(57) ABSTRACT

A mouse pad manufacturing device includes a first frame, a second frame and a base. The first frame is defined with a board thickness. The second frame is defined with a board thickness. The board thickness of the second frame is less than the board thickness of the first frame. The base has a bottom plate and a surrounding frame extended from the bottom plate. A mouse pad forming chamber is defined between the surrounding frame and the bottom plate. The first frame or the second frame is interchangeably disposed in the mouse pad forming chamber. Accordingly, the manufacturing device is suitable for various coil diameters.

### BACKGROUND

### Technical Filed

The disclosure relates to a technology of manufacturing devices of mouse pads, in particularly to a mouse pad manufacturing device for various coil thickness that can change coil height of a mouse pad.

### RELATED ART

With the rise of various wireless electronic products, people have become accustomed to using electronic products wirelessly. As a result, in the past, wired charging methods that had to be connected to a charging cable to charge electronic products have also begun to evolve towards wireless charging in recent years. Users only need to place an electronic product with a receiving coil on a wireless charger with a transmitting coil, wireless charge can be done. No wiring is required at all. Place and charge, take and go, which is very convenient.

Related-art mouse pads are also gradually being designed and developed with wireless charging methods. However, most of the manufacturing devices used to produce this mouse pad can only be used for the production of mouse pads with a single specification. For mouse pads with different specifications, other manufacturing devices are required to prepare. Not only does this result in high mold and production costs, but also the production of shared molds between similar specifications will cause the coils to be unable to be fully or properly covered by the pad body, so as to lead to poor yield of its finished products.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### SUMMARY

An object of the disclosure is to provide a manufacturing device for various coil thickness of mouse pads, that the manufacturing device can manufacture correspond to various wire diameter of coils.

To accomplish the above object, the disclosure provides a mouse pad manufacturing device for various coil thickness that can change coil height of a mouse pad, which includes a first frame, a second frame and a base. The first frame is defined with a board thickness. The second frame is defined with a board thickness. The board thickness of the second frame is less than the board thickness of the first frame. The base has a bottom plate and a surrounding frame extended from the bottom plate. A mouse pad forming chamber is defined between the surrounding frame and the bottom plate. The first frame and the second frame are replaceably disposed in the mouse pad forming chamber.

The disclosure further has the following functions. The manufacturing yield of products can be improved and the mold and manufacturing costs can be reduced.

### BRIEF DESCRIPTION OF THE DRAWINGS

FIG. 1 is an exploded view showing a first frame and a base combined with a coil of a mouse pad according to this disclosure;

FIG. 2 is a perspective view showing the first frame and the base combined with the coil of the mouse pad according to this disclosure;

FIG. 3 is a cross-sectional view showing the first frame and the base combined with the coil of the mouse pad according to this disclosure;

FIG. 4 is a top view showing a lower pad body of the mouse pad manufactured by the first frame and the base according to this disclosure;

FIG. 5 is a cross-sectional view showing a lower pad body of the mouse pad manufactured by the first frame and the base according to this disclosure;

FIG. 6 is an exploded cross-sectional view showing the first frame, the base and the lower pad body of the mouse pad according to this disclosure;

FIG. 7 is a cross-sectional view showing an upper pad body of the mouse pad manufactured by the first frame and the base according to this disclosure;

FIG. 8 is a cross-sectional view showing a second frame and the base assembled with a coil of a mouse pad according to this disclosure;

FIG. 9 is a cross-sectional view showing a lower pad body of the mouse pad manufactured by the second frame and the base according to this disclosure; and

FIG. 10 is a cross-sectional view showing an upper pad body of the mouse pad manufactured by the second frame and the base according to this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

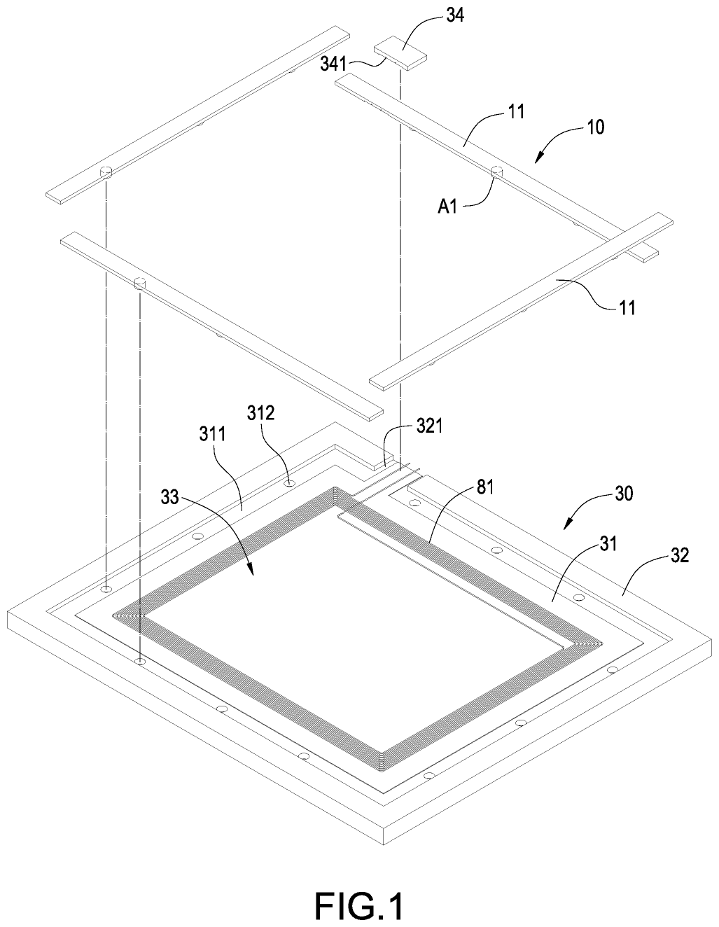

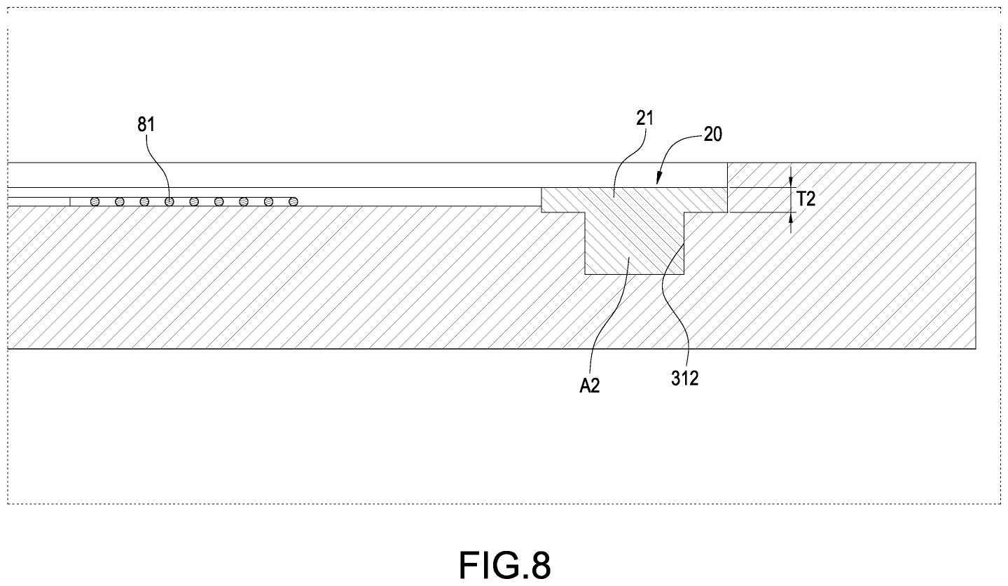

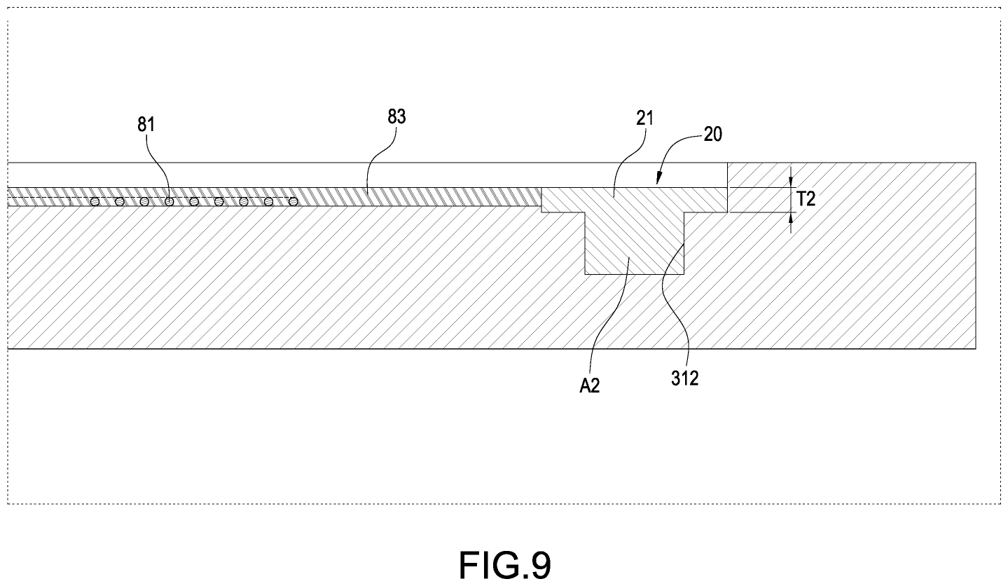

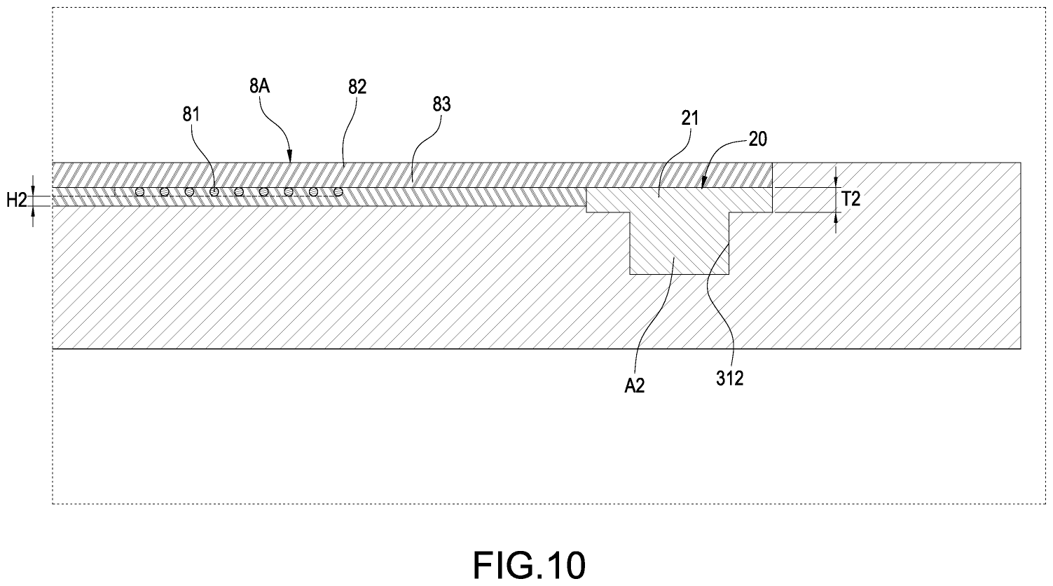

Please refer to FIGS. 1-7. The disclosure provides a manufacturing device for various coil thickness of mouse pads, which includes a first frame 10, a second frame 20 (seen in FIGS. 8-10) and a base 30.

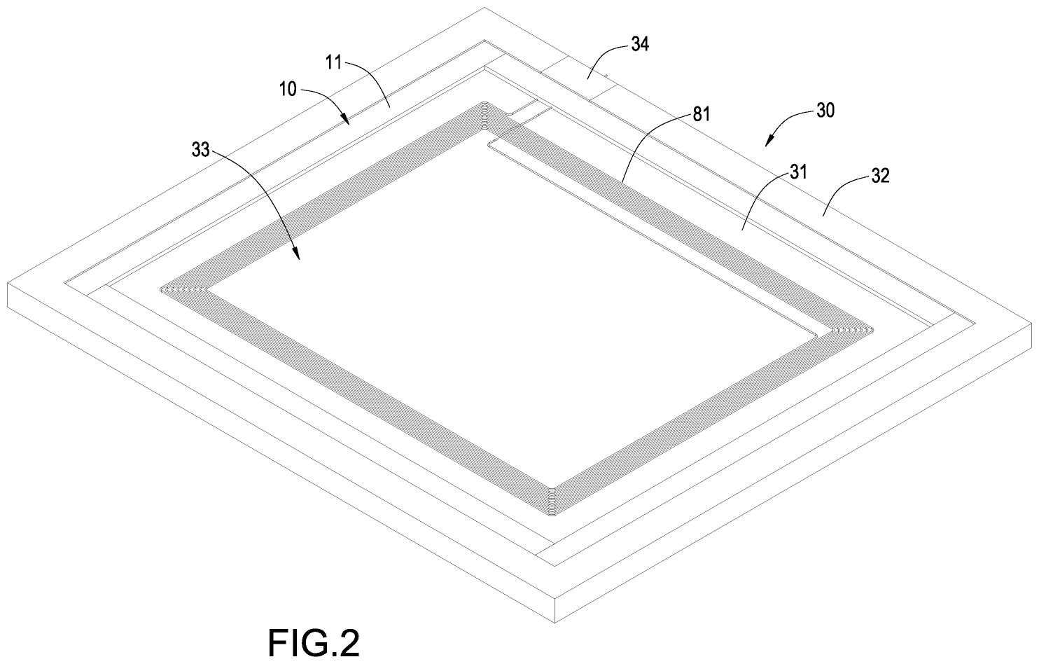

Please refer to FIGS. 1-2. The first frame 10 of the embodiment includes four first strips 11. The first strips 11 are combined with each other to enclose a rectangle, but not limited to this. Each first strip 11 is defined with a board thickness T1. The board thickness T1 of the first strips 11 are the same as each other. Each first strip 11 has multiple pins A1 extended from a lower surface thereof. The pins A1 on each first strip 11 are arranged at intervals.

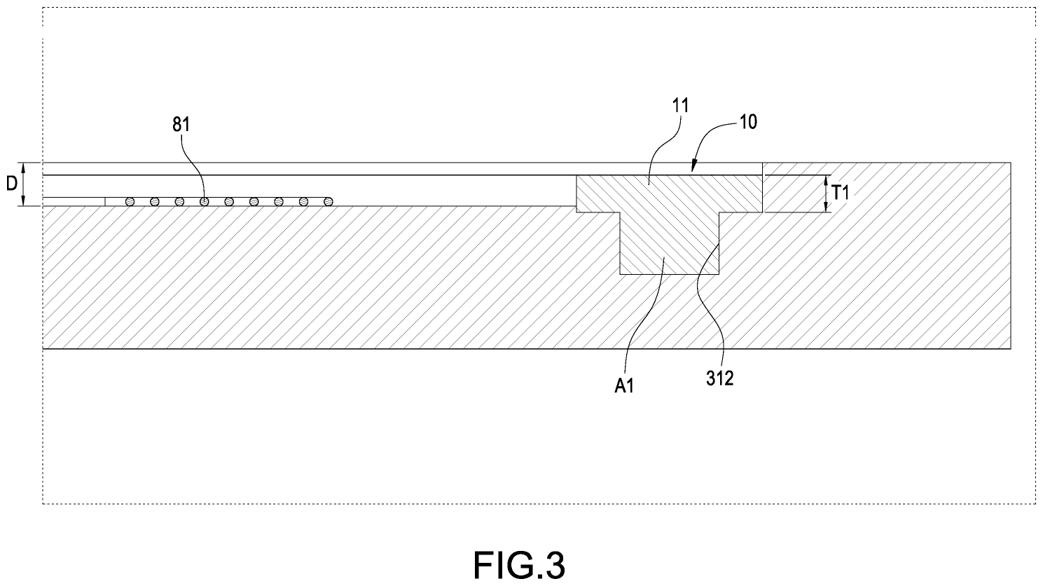

The base 30 substantially of a rectangular shape has a bottom plate 31 and a surrounding frame 32 upward extended from a periphery of the bottom plate 31. A mouse pad forming chamber 33 is defined between the surrounding frame 32 and the bottom plate 31. The mouse pad forming chamber 33 allows the first frame 10 or the second frame 20 disposed therein. A depth D of the mouse pad forming chamber 33 is greater than the board thickness T1 of each first strip 11 of the first frame 10 (as shown in FIG. 3).

In an embodiment, the bottom plate 31 is formed with a recess 311 adjacent to the surrounding frame 32. Multiple positioning holes 312 are disposed in the recess 311. The positioning holes 312 are arranged at intervals. The first strips 11 are disposed corresponding to the recess 311. The positioning holes 312 are inserted by the pins A1 respectively.

In an embodiment, the base 30 further includes a pressing plate 34, the surrounding frame 32 is disposed with a notch 321, and the pressing plate 34 is installed correspondingly to the notch 321. A lower surface of the pressing plate 34 is disposed with two wire grooves 341.

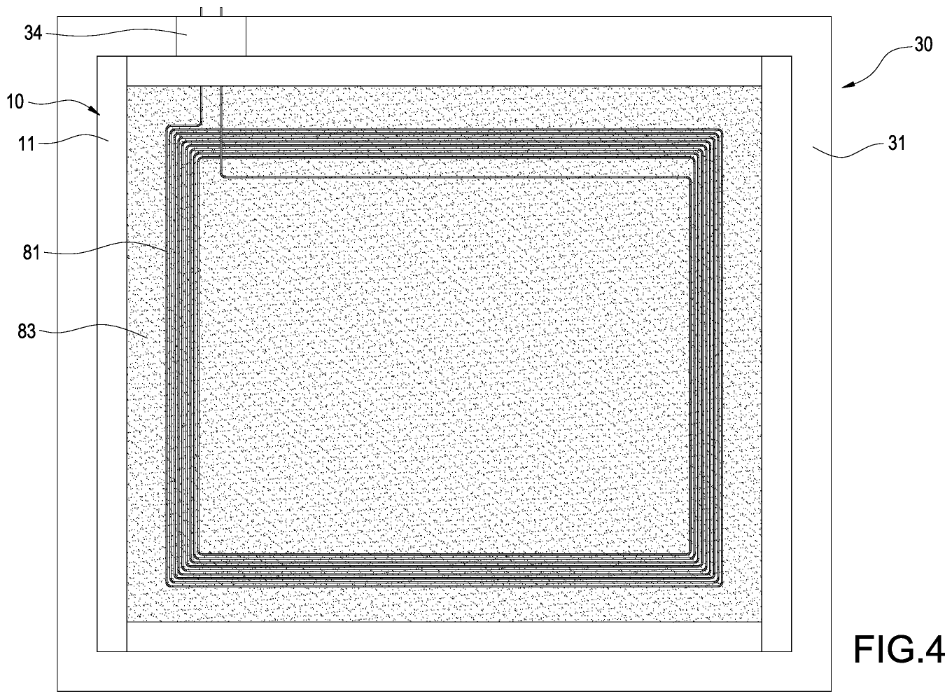

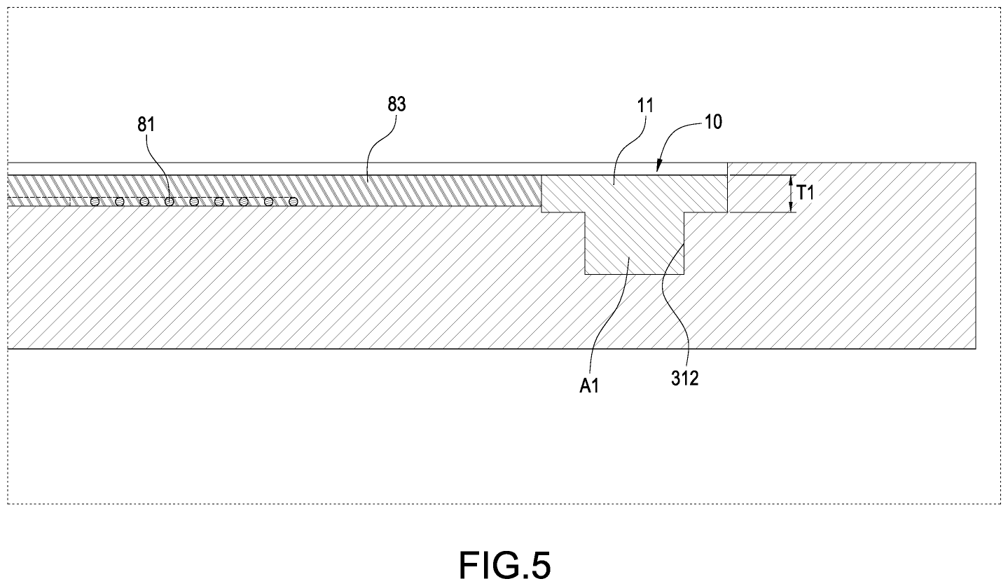

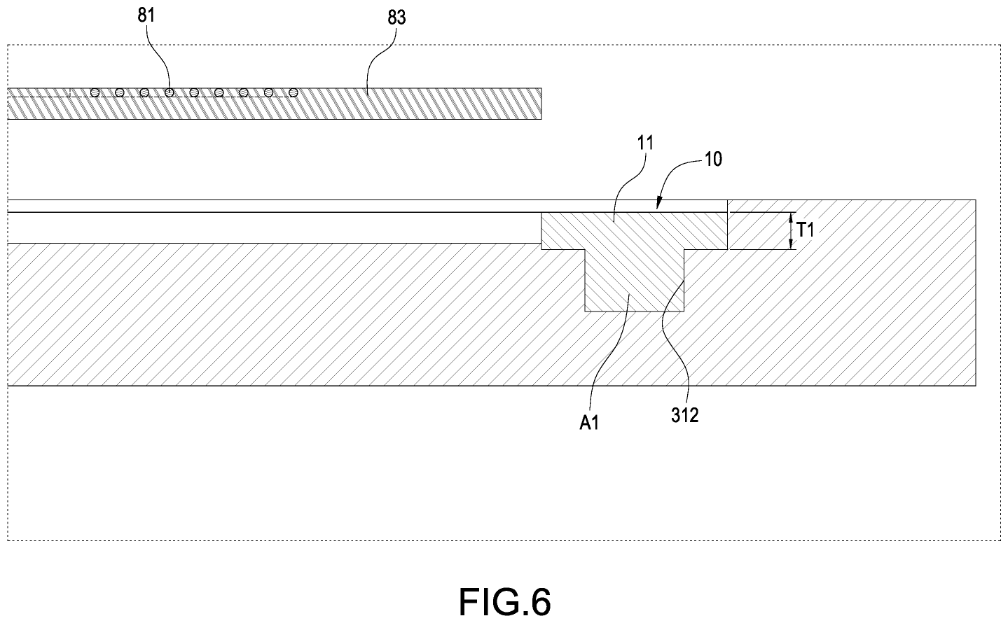

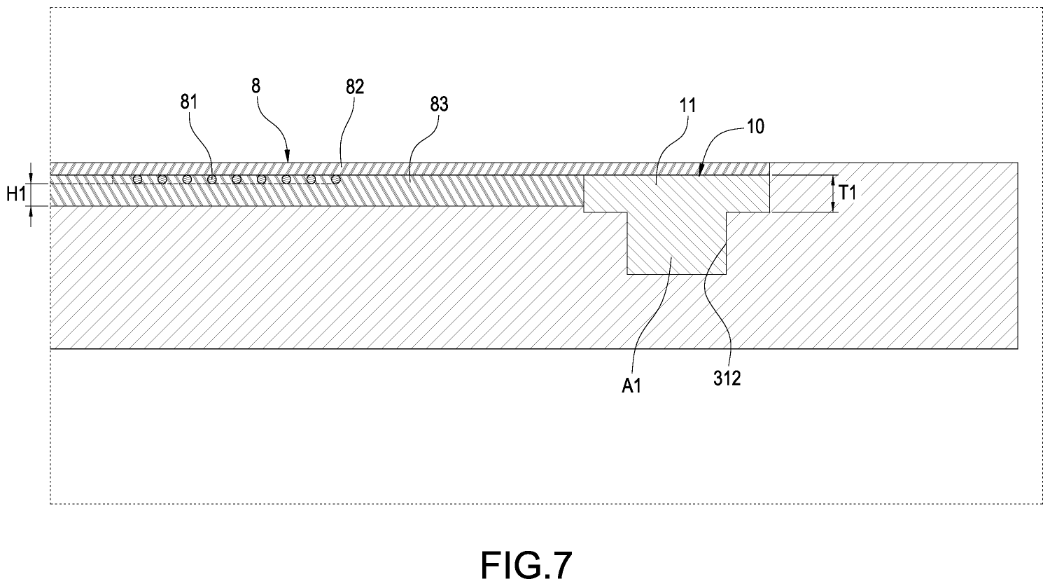

Please refer to FIGS. 3-7. The mouse pad 8 according to the embodiment is a wirelessly chargeable mouse pad. When manufacturing the mouse pad, a coil 81 of the mouse pad 8 is disposed in the mouse pad forming chamber 33, and two ends of the coil 81 respectively penetrate out of the base 30 through each wire groove 341. Then, the mouse pad forming chamber 33 is filled with melted plastic wrapping the coil 81 (as shown in FIG. 4). A flatting toll (not shown in the figures) is used for flatting the melted plastic. An upper surface of the melted plastic is aligned with an upper surface of each first strip 11 (as shown in FIG. 5). A lower pad body 83 will be formed after the melted plastic has been solidified. Next, after the lower pad body 83 is turned over, it will be placed in the mouse pad forming chamber 33 (as shown in FIG. 6). The melted plastic is filled in the mouse pad forming chamber 33 for covering the lower pad body 83 and an upper surface of each first strip 11. A flatting toll is used for flatting the melted plastic. An upper surface of the liquid plastic is flush with an upper surface of the surrounding frame 32 of the base 30 (as shown in FIG. 7). An upper pad body 82 will be formed after the melted plastic has been solidified. A height H1 is defined between the coil 81 and the lower pad body 83.

Please refer to FIGS. 8-10. The second frame 20 is approximately similar to the first frame 10 in structure. The second frame 20 of the embodiment includes four second strips 21. The second strips 21 are combined with each other to enclose a rectangle, but not limited to this. Each second strip 21 is defined with a board thickness T2. The board thickness T2 of the second strips 21 are the same as each other. The board thickness T2 is less than the board thickness T1. A lower surface of each second strip 21 has multiple pins A2 extended from a lower surface thereof. The pin A2 on each second strip 21 is arranged at intervals. Each second strip 21 is disposed correspondingly to the recess 311. Each positioning hole 312 is correspondingly inserted by each pin A2.

The manufacturing method and process of the embodiment are substantially the same as the above embodiment, so they will not be described repeatedly. The difference therebetween is that a height H2 is formed between the coil 81 and the bottom side of the lower pad body 83 of the mouse pad 8A made by the embodiment, and the height H2 is less than the height H1 of the aforementioned mouse pad 8.

While this disclosure has been described by means of specific embodiments, numerous modifications and variations could be made thereto by those skilled in the art without departing from the scope and spirit of this disclosure set forth in the claims.

What is claimed is:

1. A mouse pad manufacturing device for various coil thickness, comprising:
a first frame, defined with a board thickness;
a second frame, defined with another board thickness, and the board thickness of the second frame being less than the board thickness of the first frame; and
a base, comprising a bottom plate and a surrounding frame extended from the bottom plate, and a mouse pad forming chamber defined between the surrounding frame and the bottom plate;
wherein the first frame or the second frame are interchangeably disposed in the mouse pad forming chamber.

2. The mouse pad manufacturing device of claim 1, wherein the first frame comprises multiple first strips, each first strip is disposed with multiple pins, the bottom plate is disposed with multiple positioning holes, and the pins are respectively inserted in the positioning holes.

3. The mouse pad manufacturing device of claim 2, wherein the bottom plate is formed with a recess adjacent to the surrounding frame, and the first strips are received in the recess.

4. The mouse pad manufacturing device of claim 3, wherein the positioning holes are disposed in the recess at intervals.

5. The mouse pad manufacturing device of claim 1, wherein the second frame comprises multiple second strips, each second strip is disposed with multiple pins, the bottom plate is disposed with multiple positioning holes, and the pins are respectively inserted in the positioning holes.

6. The mouse pad manufacturing device of claim 5, wherein the bottom plate is formed with a recess adjacent to the surrounding frame, and the second strip are received in the recess.

7. The mouse pad manufacturing device of claim 6, wherein the positioning holes are disposed in the recess at intervals.

8. The mouse pad manufacturing device of claim 1, wherein the base further comprises a pressing plate, the surrounding frame is disposed with a notch, and the pressing plate is correspondingly installed at the notch.

9. The mouse pad manufacturing device of claim 8, wherein the pressing plate is disposed with at least one wire groove.

10. The mouse pad manufacturing device of claim 1, wherein a depth of the mouse pad forming chamber is greater than the board thickness of the first frame.
